(19) United States
(12) Patent Application Publication
(10) Pub. No.: US 2018/0336548 A1
(43) Pub. Date: Nov. 22, 2018

(54) NFC-INITIATED BROKERED COMMUNICATION

(71) Applicant: GOOGLE INC., Mountain View, CA (US)

(72) Inventors: Daniel Crosby, San Francisco, CA (US); Curtis Steeves, Oakland, CA (US); Marley Rafson, Mountain View, CA (US); Ankit Prasad, San Francisco, CA (US); Tania DePasquale, San Francisco, CA (US)

(21) Appl. No.: 15/596,841

(22) Filed: May 16, 2017

(51) Int. Cl. G06Q 20/32; G06Q 20/36; G06F 7/58

(52) U.S. Cl. CPC G06Q 20/3278; G06F 7/588; G06Q 20/36

(57) ABSTRACT

A communication broker system receives, via a communication network other than an NFC channel, from a first party NFC terminal system, a request to communicate a message to a user device. The request includes a first identification of an NFC tap received by the terminal system from the user device. The broker system receives a second identification of an NFC tap, this time from the user device. In response to receiving the first identification and the second identification, the broker system determines that the first identification and the second identification correspond to the same NFC tap. In response to determining that the first identification and the second identification correspond to the same NFC tap the broker system creates the message in accordance with the request. The broker system transmits, via a communications network other than a near field communication network, the created message to the user device.

### TECHNICAL FIELD

The technology disclosed herein is related to communication between radio frequency devices using diverse communication channels. Specific embodiments related to using a near field communication (NFC) channel, between a first party system and a user device, to initiate targeted communication, on behalf of the first party system to the device from a communication broker system, while the user device remains anonymous to the first party.

### BACKGROUND

Point-of-sale (POS) terminals, also known as “credit card terminals” and “payment terminals,” interface with payment devices, such as credit cards, smartcards, and payment-enabled user devices (such as smartphones), to name a few such payment devices. POS terminals are ubiquitous in merchant brick-and-mortar retail locations, and typically link to other POS equipment and various servers to complete not only payment processes, but also to complete other services such as inventory tracking and value-added services (VAS) (such as loyalty card enrollment, coupon/offer presentation).

“NFC” refers to a set of radio frequency communication protocols that enable two electronic devices at least one of which may be a portable device such as a smartphone, to establish communication by bringing the devices within 10 cm or less of each other. NFC-enabled user devices, such as NFC-enabled smartphones, are increasingly used for “contactless” payment at POS terminals that include an NFC reader in brick-and-mortar retail locations. However, NFC is a useful communication technology for a variety of applications, including access control, social networking, and gaming. An NFC communication channel may be established by “tapping” (bringing the device with 10 cm or less) an NFC-enabled user device at an NFC reader, such as an NFC-enabled POS terminal.

### SUMMARY

Embodiments of the technology disclosed herein include methods, systems, and computer program products, to communicate between first party computer systems and user devices using NFC tap initiated communication broker systems. In such embodiments, the communication broker system receives, via a communication network other than an NFC channel, from a first party NFC terminal system, a request to communicate a message to a user device. The request includes a first identification of an NFC tap received by the terminal system from the user device. The broker system receives a second identification of an NFC tap, this time from the user device. In response to receiving the first identification and the second identification, the broker system determines that the first identification and the second identification correspond to the same NFC tap. In response to determining that the first identification and the second identification correspond to the same NFC tap the broker system creates the message in accordance with the request. The broker system transmits, via a communications network other than a near field communication network, the created message to the user device.

These and other aspects, objects, features, and advantages of the example embodiments will become apparent to those having ordinary skill in the art upon consideration of the following summary description of illustrated example embodiments.

### BRIEF DESCRIPTION OF THE DRAWINGS

FIG. 1 is a block diagram depicting an operating environment to communicate between first party computer systems and user devices using NFC tap initiated communication broker systems, in accordance with certain example embodiments.

FIG. 2 is a block flow diagram depicting a method to communicate between first party computer systems and user devices using NFC tap initiated communication broker systems, in accordance with certain example embodiments.

FIG. 3 is a block flow diagram depicting a method to create, by a communication broker system, messages in accordance with requests of a NFC terminal system is shown, in accordance with example embodiments

FIG. 4 is a block diagram depicting a computing machine and a module, in accordance with certain example embodiments.

### DETAILED DESCRIPTION OF THE EXAMPLE EMBODIMENTS

### Overview

Some NFC-enabled communication solutions can push data directly to an interacting NFC-enabled user device over the NFC connection. For example, a passive NFC tag placed at a historical marker can push the same URL to each NFC-enabled user device that taps the tag. The URL can direct a browser of a tapping device to content related to the historical marker. NFC devices that push static information, such as static URLs, are not readily targeted to specific users. More sophisticated applications can push user-specific information, such as loyalty card updates pushed from an NFC-enabled POS terminal to a tapping user device.

However, using the NFC communication connection between a device such as a POS terminal and a user device presents several drawbacks. First, the amount of data communicated over a single NFC “session” is limited by several factors, including the duration of the tap(s). Second, only some NFC implementations encrypt the communication. Most rely on the need for communicating devices to be in close proximity to each other. In circumstances that require more than one tap, even encryption of the link may not be sufficient to prevent an intervening tapper. Third, not only is static information not targeted to specific users, such information can be relayed to other users, including blacklisted users. Fourth, using an NFC link to push information back to a user's device does not provide for convenient control over message traffic unwanted by the user. Fifth, regardless of the number of taps used, some information to be sent to the user device may not be available during the NFC session. For example, a server established by a manufacturer may not respond with appropriate information in a timely fashion.

Embodiments of the technology disclosed herein use a communication broker system to respond to an NFC tap identifier (ID), transmitted separately from the user device and a first-party POS terminal system, to control non-NFC communication of information to the user on behalf of (but not directly from) the first party. In many embodiments of the technology, it is not necessary that information identifying the user be available to the first party. The communication broker system matches tap identifiers received from the user device and from the POS terminal system, and then uses a rule-based approach to decide what, if any, information is forward to the user on behalf of the first party.

In a continuing example, a customer at an NFC-enabled POS terminal of a brick-and-mortar retail store taps her NFC-enabled mobile phone at the POS terminal to pay for a purchase. The POS terminal requests a tap ID from the user device. The user device generates a random (or pseudorandom) identifier and provides the generated identifier as a tap ID to the POS terminal over the NFC channel during the NFC session initiated by the tap.

The POS terminal system transmits the received tap ID to the communication broker system over one or more non-NFC communications networks, such as the Internet. The POS terminal system also requests that the communication broker system transmit an invitation to the user to have the user's loyalty card added to the user's digital wallet, and provides a one-time access code allowing the communication broker system to access the retail store's loyalty account database in order to retrieve the user's loyalty card information.

The user device also transmits the tap ID, along with some additional data including an identifier for the user's device, to the communication broker system over one or more non-NFC communications networks, such as the Internet.

After receiving both transmissions of the tap identifier, the communication broker system matches the identifiers, and then, upon finding a match, uses a rule-based approach to determine if this user is eligible to receive the information that the store operator requested be passed to the user associated with the original tap. For eligible users, the communication broker system retrieves the appropriate loyalty account information using the one time access code and the user's device identifier. The communication broker system then creates a message with the invitation that the communication broker system transmits to the user device over one or more non-NFC communications networks, such as the Internet. In the continuing example, that message includes instructions and data that allow the user to choose to add the user's loyalty card for this retail store operator to the user's electronic wallet.

Upon receiving the message, if the user accepts the invitation, the user device communicates with the user's digital wallet server to add the user's loyalty account information using the data provided in the message.

By using and relying on the methods and systems described herein, the technology disclosed herein can provide a communication channel that is not limited by the duration or data capacity of an NFC tap session. Each part of the non-NFC communication with the user device can be made secure in ways not uniformly implemented in NFC applications. As such, the technology may be employed to securely communicate information targeted to a specific user on behalf of a first party that does not need to know the identity of the specific user. Spam control can be applied at the communication broker system.

Turning now to the drawings, in which like numerals represent like (but not necessarily identical) elements throughout the figures, example embodiments are described in detail.

### Example System Architectures

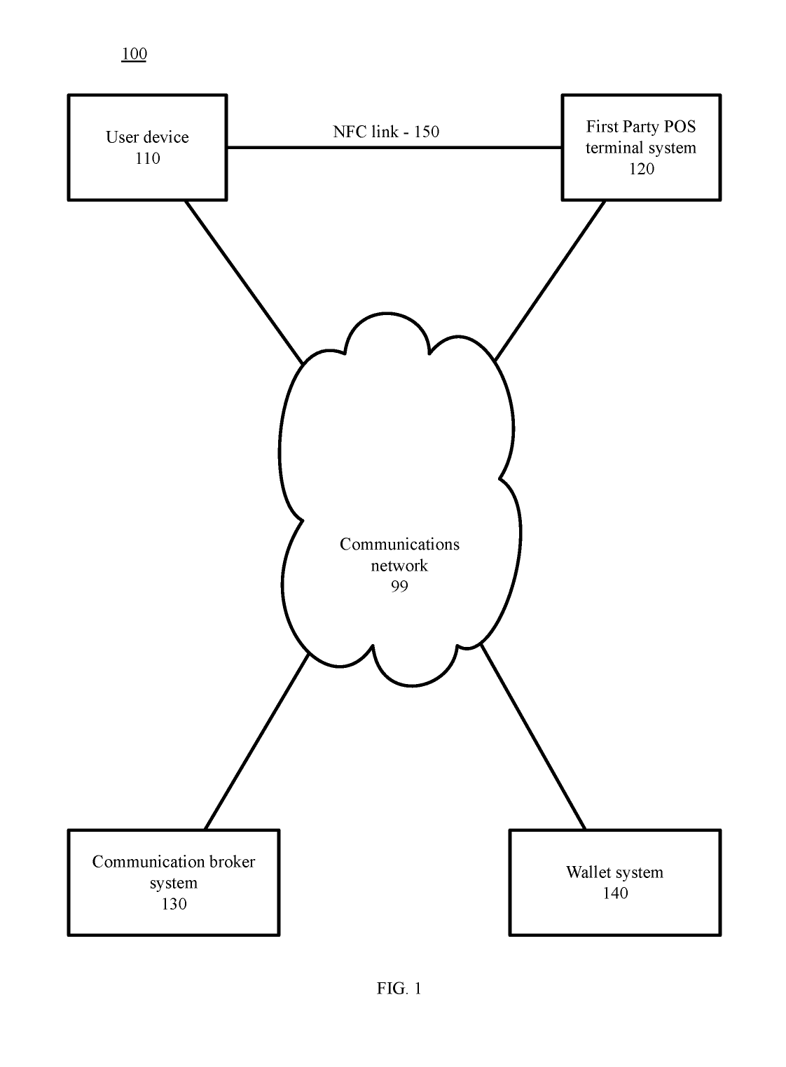

FIG. 1 is a block diagram depicting a communications and processing operating environment 100 to communicate between first party computer systems and user devices using NFC tap initiated communication broker systems, in accordance with certain example embodiments. While each server, system, and device shown in the architecture is represented by one instance of the server, system, or device, multiple instances of each can be used. Further, while certain aspects of operation of the present technology are presented in examples related to FIG. 1 to facilitate enablement of the claimed invention, additional features of the present technology, also facilitating enablement of the claimed invention, are disclosed elsewhere herein.

As depicted in FIG. 1, the example operating environment 100 includes network devices 110, 120, 130, and 140; each of which may be configured to communicate with one another via communications network 99. In some embodiments, a user associated with a device must install an application and/or make a feature selection to obtain the benefits of the technology described herein.

Network 99 includes one or more wired or wireless telecommunications means by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, any combination thereof, and any other appropriate architecture or system, other than NFC wireless communication technology, that facilitates the communication of signals, data, and/or messages. The operating environment 100 also includes an NFC wireless communication channel 150 between the user device 110 and the POS terminal system 120—when the user device 110 and the POS terminal system 120 are brought into sufficient proximity per the NFC standards. Throughout the discussion of example embodiments, it should be understood that the terms “data” and “information” are used interchangeably herein to refer to text, images, audio, video, or any other form of information that can exist in a computer-based environment.

Each network device 110, 120, 130, and 140 can include a communication module capable of transmitting and receiving data over the network 99; and user device 110 and POS terminal system 120 each include a communication subsystem capable of establishing an NFC connection, and transmitting and receiving data over NFC communication link 150. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device. In the example architecture depicted in FIG. 1, a consumer may operate user device 110. A retail merchant may operate POS terminal system 120, which can include not only the NFC reader, but also the rest of the systems deployed at the POS and each backend system. An electronic wallet provider may operate both wallet system 140 and communication broker system 130; or separate parties may operate devices 130, 140.

The network connections illustrated are examples and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, computing device 110 may be embodied as a mobile phone or handheld computer and may not include all the components described above.

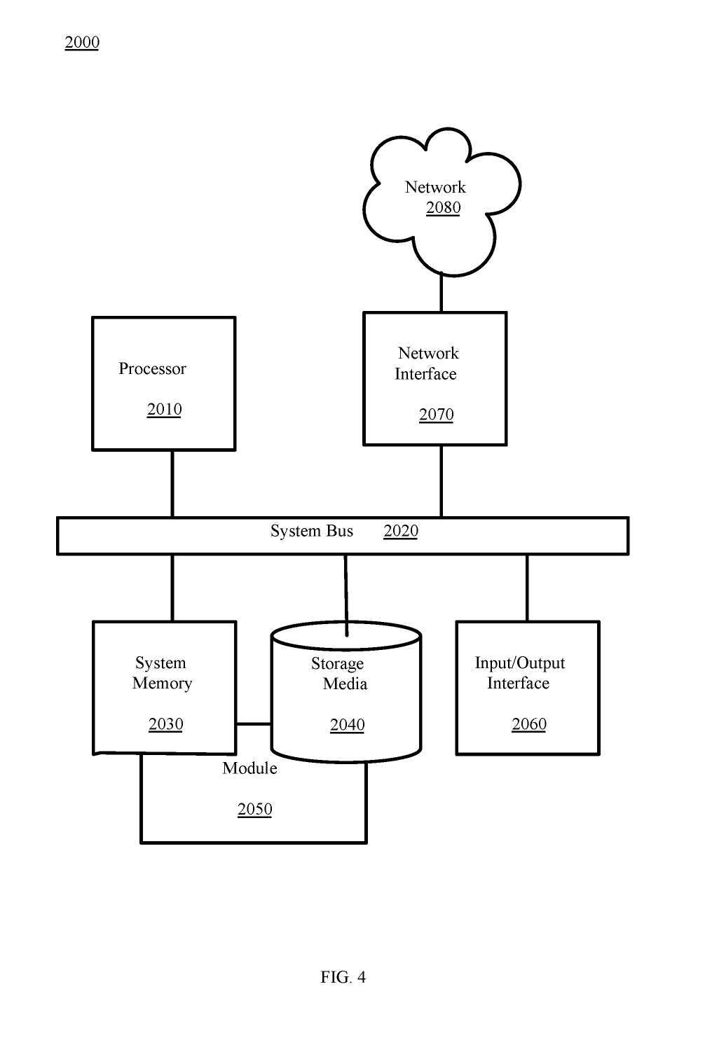

In example embodiments, the network computing devices, and any other computing machines associated with the technology presented herein, may be any type of computing machine such as, but not limited to, those discussed in more detail with respect to FIG. 4. Furthermore, any modules associated with any of these computing machines, such as modules described herein or any other modules (scripts, web content, software, firmware, or hardware) associated with the technology presented herein may be any of the modules discussed in more detail with respect to FIG. 4. The computing machines discussed herein may communicate with one another as well as other computer machines or communication systems over one or more networks, such as network 99. The network 99 may include any type of data or communications network, including any of the network technology discussed with respect to FIG. 4.

### Example Processes

The example methods illustrated in the figures are described hereinafter with respect to the components of the example operating environment 100. The example methods also can be performed with other systems and in other environments. The operations described with respect to any of the figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

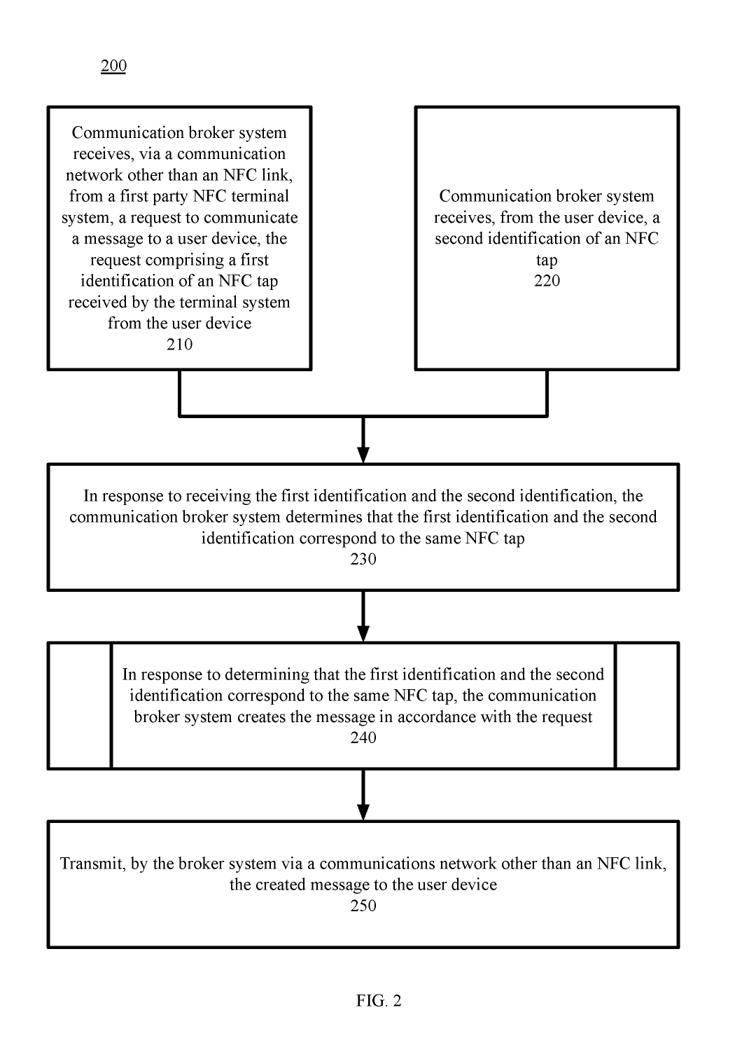

Referring to FIG. 2, and continuing to refer to FIG. 1 for context, a block flow diagram depicting a method 200 to communicate between first party computer systems and user devices using NFC tap initiated communication broker systems in accordance with certain example embodiments is shown.

In such a method 200, a communication broker system 130 receives, via a communication network 99 other than an NFC link 150, from a first party NFC terminal system 120, a request to communicate a message to a user device 110, the request comprising a first identification of an NFC tap received by the terminal system 120 from the user device 110—Block 210. In the continuing example, the customer at the NFC-enabled POS terminal system 120 of a brick-and-mortar retail store already tapped her NFC-enabled mobile phone 110 at the POS terminal system 120 to pay for the purchase. This caused the POS terminal system 120 to transmit a SELECT Other System Environment (OSE) NFC command under the SmartTag NFC protocol. SmartTag is a Value-Added Service (VAS) technology that includes NFC-enabled applications executing on a user device 110. Use of the OSE command prevents the normal round-robin selection of mobile wallet protocol on the user device, saving time and NFC link resources. When the POS terminal system 120 issued the SELECT OSE command, the user device 110 responded with NFC Application IDentifiers (AIDs) that correspond to the NFC-enabled VAS applications on the user device 110. One of those AIDs is the <SmartTap AID> that corresponds to the application that generates the tap ID. In some embodiments, tap IDs are pre-generated, whether on the user device 110, the communication broker system 120, or elsewhere, and assigned to a tap by the user device. While the continuing example uses Smart Tap over the NFC link 150, other NFC-compliant protocols, such as another International Organization for Standardization (ISO) 7816-4 compliant smartcard emulation protocol can be used.

The POS terminal system 120 then transmitted a SELECT <SmartTap AID> command that requested, over NFC link 150, to the SmartTap VAS on the user device 110, to return a tap ID and a timestamp to the POS terminal system 120 over the NFC link 150. The user device 110 generated a random identifier and provided the generated identifier as a tap ID and timestamp to the POS terminal 120 over the NFC link 150 during the NFC session initiated by the tap. The interaction between the POS terminal system 120 and the user device 110 can continue over the NFC link 150 for purposes such as payment.

The POS terminal system 120 transmitted the received tap ID and other information to the communication broker system 130 over one or more non-NFC communications networks 99, such as the Internet. In the same transmission, the POS terminal system 120 also requested that the communication broker system 130 transmit an invitation to the user to have the user's loyalty card added to the user's digital wallet 140, and provided a one-time access code allowing the communication broker system 130 to access the retail store's loyalty account database in order to retrieve the user's loyalty card information. The communication broker 130 received the transmitted information form the POS terminal system 120 via an application programming interface (API) of the communication broker 130.

While the continuing example uses a one-time access code, other embodiments of the present technology employ multiple-use access codes. In other embodiments, the user provides the user's loyalty card number to the POS terminal system 120. Providing the user's loyalty card number allows the POS terminal system 120 to transmit the user's loyalty card information, or a loyalty card object in a format compatible with the user's wallet system 140 account, to the communication broker system 130 directly. Transmission of the user's loyalty card information directly to the communication broker system 130 removes the need to transmit access codes from the POS terminal system 120 to the communication broker system 130, but does not provide the benefit to the user of anonymity with respect to the POS terminal system 120. While in the continuing example, the NFC terminal system is a POS system; this is not the case in other examples. For example, the NFC terminal system can be an access control system, such as at a building or in the lobby of a movie theater or at a transit system turnstile.

In particular, in the continuing example, the POS terminal system 120 transmitted the tap ID, the request, and the on-time access code using a JavaScript Object Notation (JSON) Web Token (JWT). JWT is an open standard that defines a way for securely transmitting information between parties as a JSON object. This information can be verified and trusted because it is digitally signed. JWTs can be signed using a secret or a public/private key pair of the sender. This approach presents a security advantage over using the NFC link 150 to move information from the POS terminal system 120 operator to the user device 110.

The communication broker system 130 receives, from the user device 110, a second identification of an NFC tap—Block 220. In the continuing example, the user device 110 also transmitted the tap ID, along with some additional data including an identifier for the user device 110, an identifier of the POS terminal system 120, and a timestamp for the tap, to the communication broker system 130 over one or more non-NFC communications networks 99, such as the Internet. As with the transmission of the tap ID, the request, and the one-time access code from the POS terminal system 120, the user device uses a JWT to encapsulate the information. As with the non-NFC interface between the POS terminal system 120 and the communication broker system 130, the communication broker system, 130 can present an API to the user device 110 for receiving the transmitted information.

In response to receiving the first identification and the second identification, the communication broker system 130 determines that the first identification and the second identification correspond to the same NFC tap—Block 230. In the continuing example, after receiving both transmissions of the tap ID, the communication broker system 130 matches the tap IDs. In other embodiments, different sequences of number and characters are used for the tap ID from the user device 110, and the tap ID from the POS terminal system 120. In such embodiments, an algorithm executed by the communication broker system 130 can match differing tap IDs. In some embodiments, information provided by the POS terminal system 120 and the user device 110, such as user device ID, POS terminal system ID, user device 110 geolocation, POS terminal system 120 geolocation, can be used to match each message to the same tap.

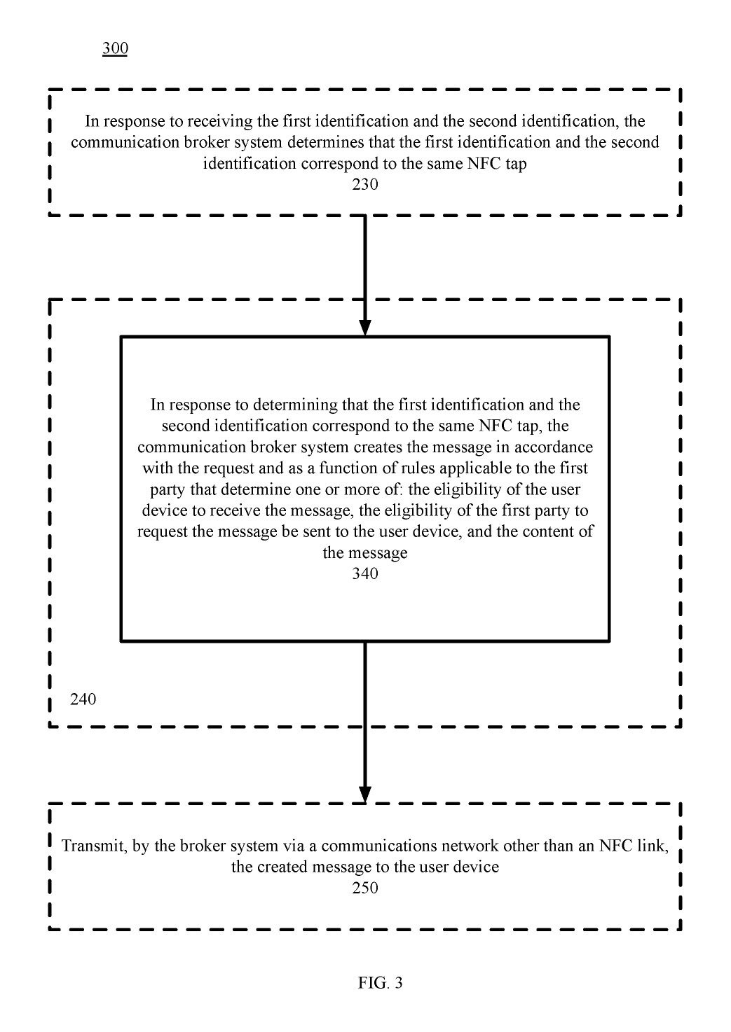

In response to determining that the first identification and the second identification correspond to the same NFC tap, the communication broker system creates the message in accordance with the request—Block 240. Referring to FIG. 3, and continuing to refer to prior figure for context, a method 300 to create, by a communication broker system 130, messages in accordance with requests of an NFC terminal system 120 is shown, in accordance with example embodiments. In such methods, creating the message includes creating the message as a function of rules applicable to one or more of the user and the first party. The rules determine one or more of: the eligibility of the user device to receive the message, the eligibility of the first party to request the message be sent to the user device, and the content of the message—Block 340.

In the continuing example, the communications broker system 130 uses the additional data, including an identifier for the user device 110 received earlier, to identify the user and determine that the user is eligible to have their loyalty card added to their wallet (for example, rule=has set up a valid wallet and accepted its terms of service; rule=the user has set up a payment card in the wallet). The communications broker system 130 further determines that the first party operator of the POS terminal system 120 is eligible to send a message because no message regarding loyalty cards has yet been sent to this user (for example, rule=only one message per month on a topic to users that have not opted out). Other eligibility criteria that filter out ineligible users and protect users from unwanted contact can be used at this point. For example, if the user merely declined a single previous offer, over a week ago, to have their loyalty card added to their wallet, but did not select not to receive any subsequent such offers, then the first party remains eligible to extend an offer to the user.

Given the eligibility of both the user to receive the message, and the first party to send the message, the communication broker system 130 creates a message notifying the user of the option to add the user's loyalty card to the user's electronic wallet. The message includes loyalty card data (in a format compatible with the electronic wallet system 140), and instructions, that when executed by the user device 110, receive approval from the user and then interface with the wallet system 140 to add the loyalty card data.

In some embodiments, the requested and transmitted message may include one or more offers, such as coupons, and the computer-executable instructions included in the message may include computer-executable instructions, that when executed by the user device 110, cause the user device to add the coupons to the user's wallet system 140 account. In some embodiments, the requested and transmitted message may include a proof of payment, for example, for fare inspectors in a public transit system.

The communications broker system 130 transmits, via a communication network 199, the created message to the user device 110—Block 250. In the continuing example, upon receiving the message at the user device 110, if the user accepts the invitation, the user device 110 communicates with the user's digital wallet server 140 to add the user's loyalty account information using the data provided in the message.

The present technology includes embodiments wherein a user device 110 sends a tap ID to a POS terminal system 120 while communicating over a supported NFC link 150 with a terminal system 120. The tap ID is a random number generated on the user device 110. The tap ID provides no explicit information about the user device 100 or its user. The user device 100 sends the tap ID and some metadata about the tap itself to the communication broker system 130. The reader of the POS terminal system 120 sends the tap ID and other information to its own POS terminal system 120 server. The POS terminal system 120 server sends the tap ID and information to be conveyed to the communication broker system 130. If there is a match between tap IDs from the user device 110 and from the POS terminal system 120, then the communication broker system 130 sends the information along to the user device 110 that performed the tap.

In some embodiments, the communication broker system 130 provides a server-to-server API to the POS terminal system 120 for pushing back data to a user device 110. The API takes as arguments an identifier for the POS terminal system 120, the tap ID, the time that the tap occurred, optionally other metadata, and the information to be conveyed to the user device 110. This information includes structured data containing a loyalty object, a URL, a text notification, or anything else agreed upon between the POS terminal system operator and the communication broker system 130 operator. The API provides for authenticated and encrypted communication, reducing the risk that unauthorized parties cannot spam the user or listen in on notifications.

The communication broker system 130 provides for a user device 100 to generate a tap ID and convey it over NFC to the POS terminal system 120, for example, the communication broker system 130 can provide an NFC-enabled application to the user device 100 to perform this function. The exchange of a tap ID between the user device 110 and the POS terminal system 120 can occur using any NFC link 150 protocol that has room for the tap ID; Smart Tap is an example of one such protocol; an ISO 7816-4 compliant smartcard emulation protocol is another example.

The communication broker 130 provides a client-server API for the user device 110 to call after a tap. This API takes as arguments the tap ID, the POS terminal system 120 ID associated with the tap, the time the tap occurred, and optionally other metadata. The API presented to the user device 110 by the communication broker system 130 stores the relevant information associated with the specific user account that made the API call.

The POS terminal system 120 configures its terminals to request the tap ID via the NFC link 150. Configuration can be, for example, by selecting the smartcard emulation applet specified by the communication broker system 130 and issuing the appropriate command to retrieve the tap ID. The POS terminal system 120 receives the tap ID, and then calls the server-to-server API described above.

The communication broker system 130 deploys functionality to match tap IDs and other metadata received from the POS terminal system 120 (via the server-to-server API) and the user device 101 (via the client-server API). The communication broker system 130 provides a notification service and user experience for the mobile device to execute after a successful match.

In an example scenario, a user types in her phone number for a loyalty program at an NFC-enabled POS terminal system 120 in a merchant location. The user taps her NFC-enabled mobile phone 110 at the merchant's POS terminal system 120 to pay. Before selecting the payment application on the mobile phone 110, the POS terminal system 120 selects the appropriate VAS application (one that supports tap IDs at NFC readers) and requests the tap ID from the phone 110. The POS terminal system 120 and the phone 110 proceed to payment inside the same NFC session and physical tap. Request and transfer of the tap ID is transparent to the user, and it provides no personal identifying information about the user or their phone. The user's phone 110 sends the tap ID, POS terminal system 120 ID, and time of tap to the communication broker system 130.

The POS terminal sends the tap ID, time of tap, and the user's loyalty number (collected earlier) to their server backend in the POS terminal system 120. The backend server generates a “virtual card” object suitable for saving to the user's account in the mobile wallet system 140, and sends it along with the tap ID, POS terminal system 120 ID, and time of tap over an authenticated, encrypted channel to the communication broker system 130.

The communication broker system 130 matches the tag ID and other metadata from both the user's phone 110 and the POS terminal system 120. If there is no match, stop. This matching logic is repeated each time a new tag ID is received either from a mobile device 110 or from a POS terminal system 120. The communication broker system 130 applies logic to decide whether to forward the virtual card to the user. The communication broker system 130 might decide, for instance, not to send a card that had already been offered to the user in the past, or just in the recent past. If applicable, the communication broker system 130 sends notification to user's mobile device 110 with the virtual card object.

The user device 110 presents the virtual card object to the user with an option to save the virtual card of the loyalty program with a single click, and an option to opt-out of future notifications from this merchant or from any merchant.

This flow does not require the message information to be available in the POS terminal system 120 at the time of the physical tap. Payloads such as pictures or video that are too large for NFC can be conveyed using embodiments of the present technology, and made available to the phone over WiFi™ or some other more suitable connection. Although an NFC pushback from the POS terminal system 120 could convey a URL, that URL would not be tailored to the device or user; it could be shared or stolen.

Each part of the communication between network devices in this technology can be made secure. Even if the tag ID is communicated from the user device 110 to the POS terminal system 120 in the clear, that information is useless to an attacker without being able to connect to the communication broker system 130, which requires authentication in the current example. All messages to the user device 110 go through the communication broker system 130, which allows for more control than technologies that do not use a communication broker system 130. The communication broker server 130 can throttle the message flow from a POS terminal system that is seen to be spamming users. Further, PII is not conveyed to the POS terminal system 120 by the mobile device 110, protecting the user's privacy. Anything that the merchant knows about the user is something the merchant knows through some other means, such as an existing loyalty program that the user chose to apply.

### Other Example Embodiments

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A method to communicate between first party computer systems and user devices using near field communication (NFC) tap initiated communication broker systems, comprising:
receiving, by a communication broker system, via a communication network other than an NFC link, from a first party NFC terminal system, a request to communicate a message to a user device, the request comprising a first identification of an NFC tap received by the terminal system from the user device;
receiving, by the broker system from the user device, a second identification of the NFC tap;
in response to receiving the first identification and the second identification, determining, by the broker system, that the first identification and the second identification correspond to the same NFC tap;
in response to determining that the first identification and the second identification correspond to the same NFC tap, creating, by the broker system, the message in accordance with the request; and
transmitting, by the broker system via a communications network other than an NFC link, the created message to the user device.

2. The method of claim 1, wherein the transmitted message includes computer-executable instructions.

3. The method of claim 2, wherein the instructions, when executed by the user device, cause a loyalty card of the user to be added to an electronic wallet of the user.

4. The method of claim 1, wherein creating the message comprises creating the message as a function of rules applicable to one or more of the user and the first party.

5. The method of claim 4, wherein the rules determine one or more of: the eligibility of the user device to receive the message, the eligibility of the first party to request the message be sent to the user device, and the content of the message.

6. The method of claim 1, further comprising:
generating, by the user device, a random number to serve as part of the first identification and as part of the second identification; and
transmitting, by the user device, the generated first identification to the terminal system and the generated second identification to the broker system.

7. The method of claim 6, wherein the user device generates the random number in response to a selection, of a brokered communication service corresponding to the brokered communication system, by the first party NFC terminal system via an NFC link during the tap.

8. A computer program product, comprising:
a non-transitory computer-readable storage device having computer-executable program instructions embodied thereon that when executed by a computer cause the computer to communicate between first party computer systems and user devices using near field communication (NFC) tap initiated communication broker systems, the computer-executable program instructions comprising:
computer-executable program instructions to receive, from a first party near field communication (NFC) terminal system, a request to communicate a message to a user device, the request comprising a first identification of an NFC tap received by the terminal system from the user device via a communication network other than an NFC link;
computer-executable program instructions to receive, from the user device, a second identification of the NFC tap;
computer-executable program instructions to determine, in response to receiving the first identification and the second identification, that the first identification and the second identification correspond to the same NFC tap;
computer-executable program instructions to create, in response to determining that the first identification and the second identification correspond to the same NFC tap, the message in accordance with the request; and
computer-executable program instructions to transmit, via a communications network other than an NFC link, the created message to the user device.

9. The computer program product of claim 8, wherein the transmitted message includes computer-executable instructions that when executed by the user device, cause a loyalty card of the user to be added to an electronic wallet of the user.

10. The computer program product of claim 8, wherein creating the message comprises creating the message as a function of rules applicable to one or more of the user and the first party.

11. The computer program product of claim 10, wherein the rules determine one or more of:
the eligibility of the user device to receive the message, the eligibility of the first party to request the message be sent to the user device, and the content of the message.

12. The computer program product of claim 8, wherein the computer-executable program instructions further comprise:
computer-executable program instructions to generate, by the user device, a random number to serve part of the first identification and the second identification; and
computer-executable program instructions to transmit, by the user device, the generated first identification to the terminal system and the generated second identification to the broker system.

13. The computer program product of claim 12, wherein the user device generates the random number in response to a selection, of a brokered communication service corresponding to the brokered communication system, by the first party NFC terminal system via an NFC link during the tap.

14. A system to communicate between first party computer systems and user devices using near field communication (NFC) tap initiated communication broker systems, the system comprising:
a storage device; and
a processor communicatively coupled to the storage device, wherein the processor executes application code instructions that are stored in the storage device to cause the system to:
computer-executable program instructions to receive, from a first party near field communication (NFC) terminal system, a request to communicate a message to a user device, the request comprising a first identification of an NFC tap received by the terminal system from the user device;
computer-executable program instructions to receive, from the user device, a second identification of the NFC tap;
computer-executable program instructions to determine, in response to receiving the first identification and the second identification, that the first identification and the second identification correspond to the same NFC tap;
computer-executable program instructions to create, in response to determining that the first identification and the second identification correspond to the same NFC tap, the message in accordance with the request; and
computer-executable program instructions to transmit, via a communications network other than a near field communication network, the created message to the user device.

15. The system of claim 14, wherein the transmitted message includes computer-executable instructions.

16. The system of claim 15, wherein the instructions, when executed by the user device, cause a loyalty card of the user to be added to an electronic wallet of the user.

17. The system of claim 14, wherein creating the message comprises creating the message as a function of rules applicable to the first party.

18. The system of claim 17, wherein the business rules determine one or more of: the eligibility of the user device to receive the message, the eligibility of the merchant to request the message be sent to the user device, and the content of the message.

19. The system of claim 14, wherein the computer-executable program instructions further comprise:
computer-executable program instructions to generate, by the user device, a random number to serve part of the first identification and the second identification; and
computer-executable program instructions to transmit, by the user device, the generated first identification and the generated second identification to the terminal system, and
wherein the first identification received by the computer is the first identification generated by the user device.

20. The system of claim 19, wherein the user device generates the random number in response to a selection, of a brokered communication service corresponding to the brokered communication system, by the first party NFC terminal system via an NFC link during the tap.
